(19) United States
(12) Patent Application Publication
(10) Pub. No.: US 2026/0012409 A1
(43) Pub. Date: Jan. 8, 2026

(54) SYSTEM AND METHOD FOR CONDUCTING INTERNET SPEED TEST VIA UNIVERSAL RESOURCE LOCATOR (URL)

(71) Applicant: JIO PLATFORMS LIMITED, Ahmedabad (IN)

(72) Inventors: Aayush BHATNAGAR, Navi Mumbai (IN); Pradeep Kumar BHATNAGAR, Navi Mumbai (IN); Sundaresh SANKARAN, Mumbai (IN); Haresh B AMBALIYA, Bhundani (IN); Bhoopendra THAKUR, Indore (IN); Surya CHUNDAWAT, Salumber (IN); Priyamvada SINGH, Noida (IN); Aditya SHARMA, Indore (IN)

(73) Assignee: JIO PLATFORMS LIMITED, Ahmedabad (IN)

(21) Appl. No.: 18/992,319

(22) PCT Filed: May 29, 2024
(86) PCT No.: PCT/IN2024/050629

§ 371 Date: Jan. 8, 2025

(30) Foreign Application Priority Data
Jun. 28, 2023 (IN) 202321043368

(51) Int. Cl. H04L 43/50; H04L 43/0864; H04L 43/0894; H04L 43/106; H04L 43/16

(52) U.S. Cl. CPC H04L 43/50; H04L 43/0864; H04L 43/0894; H04L 43/106; H04L 43/16

(57) ABSTRACT

The present disclosure provides a system (102) and a method (300) for enabling URL based speed test and data sharing. The web-based speed test provides a simple and user-friendly interface. The system (102) measures download and upload speeds, as well as latency, and displays the results in an easy-to-understand graph. It provides detailed results and allows users to choose different servers from different locations for testing. Web-based speed tests allow the user to compare the internet speeds with others in an area or globally. Regularly running speed tests over time can help the user monitor the stability and consistency of the internet connection, allowing tracking of any fluctuation in speed and performance. The application measures the time it takes for the data transfer to complete in both the upload and download directions. A speed test empowers users to measure, evaluate, and understand the internet connection's performance.

### RESERVATION OF RIGHTS

A portion of the disclosure of this patent document contains material, which is subject to intellectual property rights such as, but are not limited to, copyright, design, trademark, Integrated Circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF DISCLOSURE

The embodiments of the present disclosure generally relate to testing and measurement of network performance. In particular, the present disclosure relates to a system and method for enabling URL based speed test and data sharing.

### Definition

As used in the present disclosure, the following terms are generally intended to have the meaning as set forth below, except to the extent that the context in which they are used indicates otherwise.

For the purpose of clarity and a better understanding of the present disclosure, certain terms and expressions used herein are defined as follows, unless the context clearly dictates otherwise:

“Speed test” refers to a diagnostic tool specifically designed and optimized for use on mobile devices, such as smartphones and tablets, to assess the performance of a mobile network connection. These tests are typically accessed through dedicated applications installed on the mobile device.

“URL-based speed test” denotes a web-based tool that allows users to evaluate the performance of their internet connection. This type of test is accessible through a web browser on various devices, including desktop computers, laptops, and mobile devices, and is designed to work across different platforms and screen sizes.

“Data Transfer Time” refers to the time taken to transfer data from one location to another location.

These definitions are in addition to those expressed in the art. These definitions are in addition to those expressed in the art.

### BACKGROUND OF DISCLOSURE

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

Speed tests are designed to assess the speed and quality of an internet connection by measuring the data transfer rates between a user's device and a remote server. These tests provide valuable information about the upload and download speeds, latency, and overall stability of the internet connection. Speed tests are also relevant for mobile networks, where users assess the performance of their cellular data connections. Mobile network operators use speed tests to evaluate network coverage, capacity, and overall user experience, allowing them to optimize their infrastructure and offer better service to customers. If user facing issue in cellular and Wi-Fi network so we need to identify the issue and solve it.

Internet Service Provider (ISP) Evaluation: By Conducting a speed test, a user can assess whether an internet service provider (ISP) is delivering the internet speed promised in a service plain of the user. This helps the user determine if the user is getting what he is paying for and can be useful when comparing ISPs or troubleshooting Connectivity issues. Network Troubleshooting: if the user is experiencing slow internet speed or inconsistent performance, a web-based speed test can help identify potential issues. By measuring download and upload speeds, as well as latency, the user can identify if the problem is with his internet connection or with specific websites or online services. Device and Network Optimization: Speed tests can provide insight into the performance of the user device or network setup. By Conducting tests on different devices or comparing results between wired and wireless connections, the user can identify if there are any bottlenecks affecting their internet speed.

Patent document number CN102479151B titled “Testing method and device of webpage access speed” discloses first system time can be acquired through a first interface when a URL (uniform resource locator) address is submitted, and then a second interface can indicate the first interface to acquire second system time after the webpage rendering is finished and before the UI (user interface) is showed, and finally the total time of the webpage access can be obtained by calculating the difference value between the first system time and the second system time. Another patent document number CN102752170A titled “Network speed testing method” discloses a network speed testing. Select at least ten web portals at the user terminal, inputting a website URL (Uniform Resource Locator) address at the server of the operator through a simulated user at the user terminal by a browser address bar so as to carry out web browsing and obtain the information about HTTP service availability, DNS (Domain Name Server) delay, TCP (Terminal Control Protocol) delay and the initial package delay of an HTTP page, thus obtaining the test result.

Conventional systems and methods face difficulty in selection of managing multiple radio nodes in an optimized manner. There is, therefore, a need in the art to provide a method and a system that can overcome the shortcomings of the existing prior arts.

### OBJECTS OF THE PRESENT DISCLOSURE

Some of the objects of the present disclosure, which at least one embodiment herein satisfies are as listed herein below.

An object of the present disclosure is to provide a system and method enabling URL-based speed tests and data sharing.

An object of the present disclosure is to analyse network performance, improve the service, and generate aggregate statistics.

An object of the present disclosure is to review the privacy policy and terms of service of the speed test provider before conducting a test.

An object of the present disclosure is to implement encryption protocols and following industry-standard practices to protect data from unauthorized access or breaches.

### SUMMARY

The present disclosure discloses a method of conducting an internet speed test for a network via a universal resource locator (URL). The method includes initiating a speed test session by accessing a web-based interface through the URL on a user device. The method includes automatically fetching a current location of the user device. The method includes determining a nearest testing server based on the current location of the user device. The method includes establishing a connection between the user device and the determined nearest testing server. The method includes conducting a plurality of speed tests by measuring a number of data packets received and transmitted between the user device and the nearest testing server. The method includes calculating a confidence value representing stability of the network using the measured number of data packets. The method includes displaying results of the plurality of conducted speed tests on a display screen of the user device if the calculated confidence value is greater than a predefined threshold value.

In an embodiment, the plurality of speed tests includes a latency test, a download speed test, and an upload speed test.

In an embodiment, the method further comprising a step of reconducting the plurality of speed tests if the calculated confidence value is less than the predefined threshold value.

In an embodiment, the method further comprising a step of conducting the latency test by sending and receiving data packets between the user device and the nearest testing server.

In an embodiment, the method further comprising a step of conducting the download speed test by transferring data from the nearest testing server to the user device and calculating the download speed based on a data transfer time.

In an embodiment, the method further comprising a step of conducting the upload speed test by transferring data from the user device to the nearest testing server and calculating the upload speed based on the data transfer time.

In an embodiment, the connection is a Hypertext Transfer Protocol (HTTP) connection or a Transmission Control Protocol (TCP) connection.

The present disclosure discloses a system for conducting an internet speed test for a network via a universal resource locator (URL). The system includes a web-based interface, a location access component, a server selection unit, a network connection component, and a testing component. The web-based interface is configured to receive a test session initiation request from a user through the URL on a user device. The location access component, on receiving the test session initiation request, is configured to fetch a current location of the user device. The server selection unit is configured to cooperate with the location access component to receive the current location of the user device and is further configured to determine a nearest testing server based on the received location of the user device. The network connection component is configured to establish a connection between the user device and the determined nearest testing server. The testing component is configured to conduct a plurality of tests by measuring a number of data packets received and transmitted between the user device and the nearest testing server. The testing component is further configured to calculate a confidence value using the measured data packets for the network under test and display results of the plurality of conducted speed tests on a display screen of the user device if the calculated confidence value is greater than a threshold value.

In an embodiment, the plurality of tests includes a latency test, a download speed test, and an upload speed test.

In an embodiment, the testing component is configured to reconduct the plurality of speed tests if the calculated confidence value is less than the threshold value.

In an embodiment, the testing component is configured to conduct the latency test via a latency testing component by sending and receiving data packets between the user device and the nearest testing server.

In an embodiment, the testing component is configured to conduct the download speed test via a download speed testing component by transferring data from the nearest testing server to the user device and calculating the download speed based on a data transfer time.

In an embodiment, the testing component is configured to conduct the upload speed test via an upload speed testing component by transferring data from the user device to the nearest testing server and calculating the upload speed based on the data transfer time.

In an embodiment, the connection is a Hypertext Transfer Protocol (HTTP) connection or a Transmission Control Protocol (TCP) connection.

In an embodiment, the location access component is configured to utilize a Geolocation Application programming interface (API) provided by a web browser to obtain the geographic position of the user device.

The present disclosure discloses a user equipment configured to conduct an internet speed test for a network via a universal resource locator (URL). The user equipment includes a processor, and a computer readable storage medium storing programming instructions for execution by the processor. Under the programming instructions, the processor is configured to receive a test session initiation request by a user through the URL on the user equipment. Under the programming instructions, the processor is configured to fetch a current location of the user equipment via a location access component. Under the programming instructions, the processor is configured to receive the current location of the user equipment using a server selection unit and determine a nearest testing server based on the received location of the user device. Under the programming instructions, the processor is configured to establish a connection with the determined nearest testing server. Under the programming instructions, the processor is configured to conduct a plurality of speed tests by measuring a number of data packets received and transmitted between the user equipment and the nearest testing server. Under the programming instructions, the processor is configured to calculate a confidence value using the measured data packets for the network under test. Under the programming instructions, the processor is configured to display results of the plurality of conducted speed tests on a display screen of the user equipment if the calculated confidence value is greater than a threshold value.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components or circuitry commonly used to implement such components.

FIG. 1 illustrates an exemplary architecture of a system for conducting an internet speed test for a network via a universal resource locator (URL), in accordance with embodiments of the present disclosure.

FIG. 2 illustrates an exemplary block diagram of the system, in accordance with embodiments of the present disclosure.

FIG. 3 illustrates an exemplary workflow diagram for enabling URL based speed test, in accordance with embodiments of the present disclosure.

FIG. 4 illustrates an exemplary architecture for conducting an internet speed test, in accordance with embodiments of the present disclosure.

FIGS. 5A-5D illustrate various exemplary user interfaces representing various pages of a speed test mobile application, in accordance with embodiments of the present disclosure.

FIG. 6 illustrates an exemplary computer system in which or with which embodiments of the present disclosure may be implemented.

FIG. 7 illustrates exemplary steps of a method for conducting an internet speed test for the network via the URL, in accordance with embodiments of the present disclosure.

The foregoing shall be more apparent from the following more detailed description of the disclosure.

### LIST OF REFERENCE NUMERALS

100—Network Architecture
102—System
104—Network
106—Server
108-1, 108-2 . . . 108-N—User Equipments
110-1, 110-2 . . . 110-N—Users
112—Web-based Interface
114—Location Access Component
116—Server Selection Unit
118—Network Connection Component
120—Testing Component
122—Latency Testing Component
124—Download Speed Testing Component
126—Upload Speed Testing Component
128—Display Screen
130—Database
610—External Storage Device
620—Bus
630—Main Memory
640—Read Only Memory
650—Mass Storage Device
660—Communication Port
670—Processor

### BRIEF DESCRIPTION OF THE INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above. Some of the problems discussed above might not be fully addressed by any of the features described herein. Example embodiments of the present disclosure are described below, as illustrated in various drawings in which like reference numerals refer to the same parts throughout the different drawings.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive like the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is to describe particular embodiments only and is not intended to be limiting the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any combinations of one or more of the associated listed items. It should be noted that the terms “mobile device”, “user equipment”, “user device”, “communication device”, “device” and similar terms are used interchangeably for the purpose of describing the invention. These terms are not intended to limit the scope of the invention or imply any specific functionality or limitations on the described embodiments. The use of these terms is solely for convenience and clarity of description. The invention is not limited to any particular type of device or equipment, and it should be understood that other equivalent terms or variations thereof may be used interchangeably without departing from the scope of the invention as defined herein.

As used herein, an “electronic device”, or “portable electronic device”, or “user device” or “communication device” or “user equipment” or “device” refers to any electrical, electronic, electromechanical, and computing device. The user device is capable of receiving and/or transmitting one or parameters, performing function/s, communicating with other user devices, and transmitting data to the other user devices. The user equipment may have a processor, a display, a memory, a battery, and an input-means such as a hard keypad and/or a soft keypad. The user equipment may be capable of operating on any radio access technology including but not limited to IP-enabled communication, Zig Bee, Bluetooth, Bluetooth Low Energy, Near Field Communication, Z-Wave, Wi-Fi, Wi-Fi direct, etc. For instance, the user equipment may include, but not limited to, a mobile phone, smartphone, virtual reality (VR) devices, augmented reality (AR) devices, laptop, a general-purpose computer, desktop, personal digital assistant, tablet computer, mainframe computer, or any other device as may be obvious to a person skilled in the art for implementation of the features of the present disclosure.

Further, the user device may also comprise a “processor” or “processing unit” includes processing unit, wherein processor refers to any logic circuitry for processing instructions. The processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor is a hardware processor.

As portable electronic devices and wireless technologies continue to improve and grow in popularity, the advancing wireless technologies for data transfer are also expected to evolve and replace the older generations of technologies. In the field of wireless data communications, the dynamic advancement of various generations of cellular technology are also seen. The development, in this respect, has been incremental in the order of second generation (2G), third generation (3G), fourth generation (4G), and now fifth generation (5G), and more such generations are expected to continue in the forthcoming time.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

The demand for fast and reliable internet is increasing, especially for activities like gaming, audio, and video streaming on mobile devices. Users want better network quality to minimize delays, leading to a growing interest in real-time monitoring of a speed of the network. Speed tests are commonly done on individual devices. However, when many devices perform speed tests at once, it can overload the server and affect background operations and result processing.

The existing speed test systems are configured to measure the latency, jitter, download, and upload bandwidth of the network connection between a user device and one or more speed test servers. A speed test can be performed on various platforms such as the web, mobile phones, tablets, desktop computers, and routers. During the speed test, a number of lost packets and bi-directional traceroutes are measured, and device and network information is collected. The objective of the speed test is to capture a snapshot of the internet for a specific time, place, device, and network each time a user initiates a request for a speed test.

However, these existing speed test systems often fall short due to the absence of nearby speed test servers. The reliability and functionality of these speed test systems are heavily dependent on the proximity of servers to the user's location. When the speed test servers are situated far away, the results may not truly reflect the user's actual internet speed.

Accordingly, there is a need for systems and methods for performing speed tests in a network more accurately and efficiently.

Hereinafter, exemplary embodiments of the present disclosure will be described with reference to the accompanying drawings.

The difference between a mobile based speed test, and an URL-based speed test include, but not limited to a Platform, User Interface, Native vs. Web Technologies, Integration with Device APIs, and Distribution and Installation

Platform: Mobile speed tests are specifically designed and optimized for mobile devices, such as smartphones and tablets. They are typically accessed through dedicated mobile applications that are installed on the device. On the other hand, URL-based speed tests are accessed through web browsers on various platforms, including desktops, laptops, and mobile devices.

User Interface: Mobile speed test applications have user interfaces specifically tailored for mobile devices, with optimized layouts and interactions for touchscreens. URL-based speed tests have user interfaces designed to work across different devices and screen sizes, often adapting to the specific device and browser capabilities.

Native vs. Web Technologies: Mobile speed test applications are built using native programming languages and frameworks specific to the target mobile platform, such as Java or Kotlin for Android and Objective-C or Swift for iOS. They have direct access to the device's hardware and operating system functionalities. URL-based speed tests, on the other hand, are built using web technologies like HTML, CSS, and JavaScript. They run within the browser environment and rely on browser APIs and capabilities to perform the speed test.

Integration with Device APIs: Mobile speed test applications can directly access device-specific APIs and sensors to gather additional information, such as signal strength, network type, and device performance metrics. This allows mobile speed tests to provide more detailed insights into the mobile network performance. URL-based speed tests have limited access to device APIs and can primarily gather information related to the browser and network connection.

Distribution and Installation: Mobile speed test applications need to be downloaded and installed from app stores or other distribution platforms. They require storage space on the device and can have regular updates provided by the app developer. URL-based speed tests, on the other hand, are instantly accessible through a web browser without the need for installation. Users can navigate to the speed test website and initiate the test.

The present disclosure serves as a speed test that provides solutions for mobile and web. Further, comparison and benchmarking Web-based speed tests allow a user to compare his internet speeds with others in an area specific to the user device or globally. Regularly running speed tests over time can help a network operator monitor the stability and consistency of the internet connection, allowing tracking of any fluctuation in speed and performance.

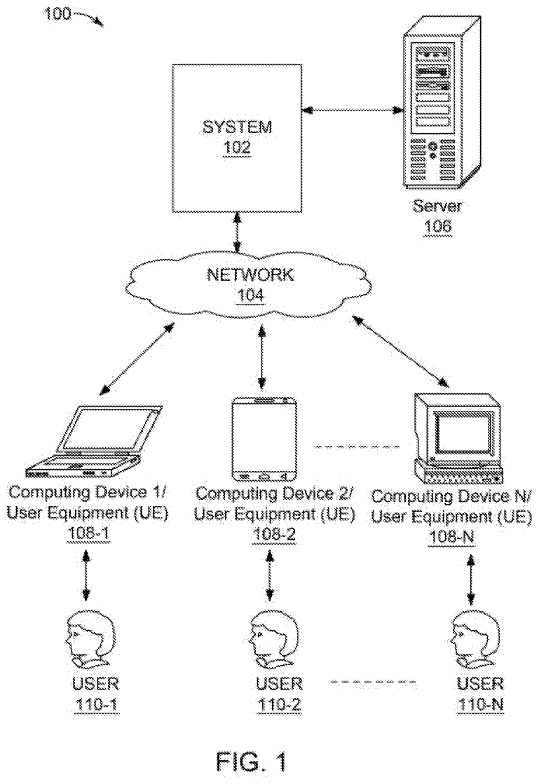

The various embodiments throughout the disclosure will be explained in more detail with reference to FIGS. 1-6.

FIG. 1 illustrates a network architecture (100) of a system (102) for conducting an internet speed test for a network via a universal resource locator (URL), in accordance with embodiments of the present disclosure.

Referring to FIG. 1, the network architecture (100) is implemented for enabling a speed test of internet connection using a speed test mobile application (also referred to as a mobile application). In an embodiment, the system (102) is connected to a network (104), which is further connected to at least one computing device (108)-1, 108-2, . . . 108-N (collectively referred to as computing device (108), herein) associated with one or more users 110-1, 110-2, . . . 110-N (collectively referred as computing device 110, herein). The computing device (108) may be personal computers, laptops, tablets, wristwatches, or any custom-built computing device integrated within a modern diagnostic machine that can connect to a network as an IoT (Internet of Things) device. Further, the network (104) can be configured with a centralized server (106) that stores compiled data.

In an embodiment, the system (102) may receive at least one input data (test session initiation request) from the at least one computing device (108). A person of ordinary skill in the art will understand that the at least one computing device (108) may be individually referred to as computing device (108) and collectively referred to as computing devices 108. In an embodiment, the computing device (108) may also be referred to as User Equipment (UE). Accordingly, the terms “computing device” and “User Equipment” may be used interchangeably throughout the disclosure.

In an embodiment, the computing device (108) may transmit the at least one captured data packet over a point-to-point or point-to-multipoint communication channel or network (104) to the system (102).

In an embodiment, the computing device (108) may collect, analyze, and share data from the system (102) through the communication network (104).

In an exemplary embodiment, the network (104) may include, but not be limited to, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. In an exemplary embodiment, the network (104) may include, but not be limited to, a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof.

In an embodiment, the computing device (108) may communicate with the system (102) via a set of executable instructions residing on any operating system. In an embodiment, the one or more computing devices 108 may include, but not be limited to, any electrical, electronic, electro-mechanical, or an equipment, or a combination of one or more of the above devices such as mobile phone, smartphone, Virtual Reality (VR) devices, Augmented Reality (AR) devices, laptop, a general-purpose computer, desktop, personal digital assistant, tablet computer, mainframe computer, or any other computing device, wherein the one or more computing devices (108) may include one or more in-built or externally coupled accessories including, but not limited to, a visual aid device such as camera, audio aid, a microphone, a keyboard, input devices such as touch pad, touch enabled screen, electronic pen, receiving devices for receiving any audio or visual signal in any range of frequencies, and transmitting devices that can transmit any audio or visual signal in any range of frequencies. It may be appreciated that the one or more computing devices (108) may not be restricted to the mentioned devices and various other devices may be used.

A layout of the output end of the system (102) is described, as it may be implemented. The system (102) can be configured to provide a common solution for mobile and web, including download speed, upload speed, ping test, server selection, and data sharing.

In an embodiment, test initialization is conducted when a speed test on a URL is initiated. The test starts by establishing a connection between the user device and the speed test server. The system (102) is configured to find a nearest server using the latitude and longitude associated with the user device. The nearest server is usually located in a data center with a high-speed internet connection. Further, data transfer is conducted once the connection is established, and the speed test server starts sending and receiving data packets to and from the user device. These data packets are usually sent in chunks of varying sizes.

Further, download speed measurement can be enabled to measure the download speed; the speed test server sends a series of data packets to the user device. Record the time when the data packets are received and calculate the download speed by dividing the amount of data received by the time taken. Furthermore, upload speed measurement is conducted to measure the upload speed. The user device transmits a series of data packets back to the speed test server. The server records the time taken to receive these packets and calculates the upload speed using a similar calculation as the download speed. Latency measurement is conducted to measure latency of the network. For conducting latency measurement, the speed test server sends a small data packet to the user device, and the user device immediately sends it back. The time taken for this round trip is recorded as the as the latency or ping time. Once the data transfer and measurements are completed, the speed test portal (accessed by URL) is configured to display the results to an end user. These results usually include the download speed, upload speed, latency of the network, and server details. After all the measurements are complete, the system (102) is configured to send the results to the backend server to store and reference for future comparisons and benchmarks.

In an embodiment, the system is connected to the network (104), which is connected to at least one computing device (108) may include but not be limited to personal computers, smartphones, laptops, tablets, smartwatches, as well as other IoT devices that support a display. When the results are received via the network (104), the receiver can understand the speed of the network predicated by the system (102), as well as take steps to prevent further degradation of the speed of the network based on suggested recommendations.

In an embodiment, the network (104) is further configured with a centralized server (106) including a database. The database has been designed specifically to store all the results that are generated by the network. The decision to use the centralized server and the database is based on the need for a reliable and efficient system that can easily manage the large volume of data generated by the network. One of the key advantages of using the centralized server is that it allows for easy retrieval of data whenever there is a need to reference it in the future. This means that all results generated by the network can be accessed from a single location, which simplifies the process of managing and analyzing the data. In addition to storing the results, the centralized server is also responsible for managing the security and integrity of the data. This is achieved through the use of advanced encryption and access control mechanisms that ensure that only authorized users can access the data.

In an embodiment, the computing device (108) associated with the one or more user 110 may transmit the at least one captured data packet over a point-to-point or point-to-multipoint communication channel or network (104) to the system (102).

Although FIG. 1 shows exemplary components of the network architecture (100), in other embodiments, the network architecture (100) may include fewer components, different components, differently arranged components, or additional functional components than depicted in FIG. 1. Additionally, or alternatively, one or more components of the network architecture (100) may perform functions described as being performed by one or more other components of the network architecture (100).

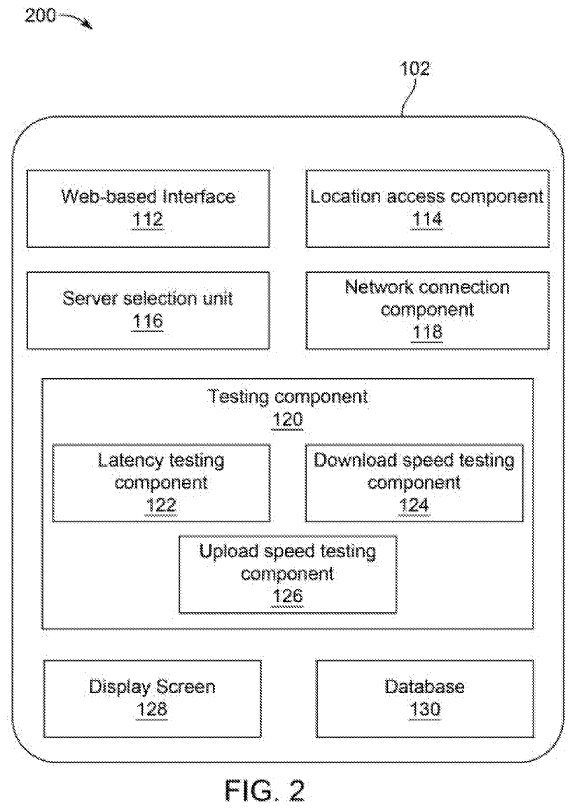

FIG. 2 illustrates an exemplary block diagram (200) of the system (102), in accordance with embodiments of the present disclosure.

As displayed in FIG. 2, the system (102) includes a web-based interface (112), a location access component (114), a server selection unit (116), a network connection component (118), a testing component (120), which further includes a latency testing component (122), a download speed testing component (124), an upload speed testing component (126), and a display screen (128).

The network (104) represents the totality of the hardware and software resources involved in connecting computers and devices to enable data exchange. This includes not just the Internet but also the protocols that govern data transmission, such as the Internet Protocol (IP) suite. These protocols ensure that data packets are routed across diverse networks and reach their correct destinations. Implementation can vary widely, ranging from cellular networks utilizing various generations of mobile telecommunications technology (e.g., 4G, 5G) to Wi-Fi networks employing IEEE 802.11 standards and wired broadband networks using digital subscriber line (DSL) or fiber-optic technology.

The web-based interface (112) is configured to receive the test session initiation request from the user through the URL on the user device. The web-based interface (112) is typically a web-based application accessed via a browser, constructed using HTML, CSS, and JavaScript, which may leverage frameworks like Angular or React for a responsive design. The web-based interface (112) is configured to be device-agnostic, offering a consistent user experience across desktops, tablets, and mobile phones. The web-based interface (112) provides interactive elements such as buttons to initiate tests, input fields for settings, and graphical displays for results.

On receiving the test session initiation request, the location access component (114) is configured to fetch a current location of the user device. The location access component (114) is configured to utilize the Geolocation API provided by modern web browsers to obtain the geographic position of the user device. The location access component (114), upon receiving the user's consent, retrieves the latitude and longitude data associated with the user device. The latitude and longitude data are essential in a server selection process, where proximity can influence test accuracy due to latency variations with distance. Implementation can also include error handling for instances when location data is unavailable, or permission is denied.

The server selection unit (116) is configured to cooperate with the location access component (114) to receive the current location of the user device. The server selection unit (116) is configured to use the location data to determine the nearest testing server from a pool of testing servers distributed geographically. The server selection unit (116) is further configured to select the nearest testing server based on the received location of the user device. The selection process can incorporate proximity, current server load, and health status, ensuring the chosen server can handle the test without biasing results due to server-side issues. The server selection unit (116) can be implemented as part of the back-end infrastructure, with algorithms that calculates the great-circle distance between the user and each server.

The network connection component (118) is configured to establish a connection with the determined nearest testing server. The network connection component (118) is configured to establish a network connection with the selected testing server using HTTP/TCP protocols. TCP (Transmission Control Protocol) is chosen for its reliability in data transmission, as it provides error checking and guarantees the delivery of data packets in the order they were sent, which is crucial for an accurate speed test. The HTTP protocol layered on top of TCP enables communication between the user's browser and the server. Implementation details include opening a socket connection to the server and managing the sending and receiving of test data packets.

The testing component (120) is configured to conduct a plurality of tests by measuring a number of data packets received and transmitted between the user device and the nearest testing server. In an example, the plurality of tests includes a latency test, a download speed test, and an upload speed test. The testing component (120) is further configured to calculate a confidence value using the measured data packets for the network under test. In an example, the confidence value represents a network stability. For calculating the confidence value, the system is configured to assign a value against each measured value of the Latency, Download and Upload Speed test results. For example, if the latency is less than 100 ms, assign a score of 100. If the latency is between 100 ms and 200 ms, assign a score based on a linear scale between 0 and 100. For storing a value corresponding to the speed test result, calculate a difference between download speed and upload speed and assign a score based on this difference. A lower difference should result in a higher score. For example: If the difference between download speed and upload speeds is less than 10 Mbps, assign a score of 100. If the difference is between 10 Mbps and 20 Mbps, assign a score based on a linear scale between 0 and 100. The scores from latency and speed are combined, and a weighted average is performed. For calculating the confidence value, the combined score is normalized to a scale of 0 to 100 to represent the confidence value.

The testing component (120) is configured to display results of the plurality of conducted speed tests on the display screen (128) of the user device if the calculated confidence value is greater than a threshold value. In an example, the testing component (120) is configured to reconduct the plurality of speed tests if the calculated confidence value is less than the threshold value.

Within the testing component (120), the latency testing component (122) measures the time taken for a data packet to travel to the server and back to the user's device, providing a latency or ping metric. The download speed testing component (124) calculates the data download rate from the server to the user's device, while the upload speed testing component (126) measures the rate of data transfer from the user's device to the server.

In one aspect, the latency testing component (122) measures the round-trip time (RTT) of a packet traveling from the client to the server and back, also known as ping. Implementation involves sending a small data packet, recording the timestamp when it was sent, and then recording the timestamp upon receipt of the server's response, calculating the difference to determine latency. The testing component (120) is configured to conduct the latency test via the latency testing component (122) by sending and receiving data packets between the user device and the nearest testing server.

In one aspect, the download speed testing component (124) calculates the download bandwidth by requesting a file or stream of data from the server and measuring the time it takes to complete the download. The speed is calculated by dividing the size of the data by the time taken to download. Multithreading might be used here to simulate parallel download streams, mirroring real-world data consumption. The testing component (120) is configured to conduct the download speed test, via the download speed testing component (124), by transferring data from the nearest testing server to the user device and calculating the download speed based on a data transfer time.

In one aspect, the upload speed testing component (126) measures upload bandwidth by sending data from the client to the server and timing the process. The upload speed is determined in a similar fashion to the download speed but often involves different data patterns to account for the fact that upload processes can behave differently from downloads due to different network traffic management policies. The testing component (120) is configured to conduct the upload speed test, via the upload speed testing component (126), by transferring data from the user device to the nearest testing server and calculating the upload speed based on the data transfer time.

The display screen (128) is configured to present the test outcomes in an interpretable format to the user. It may include graphical representations such as bar graphs or speedometers. The implementation could use interactive visualizations that update in real time as the test proceeds.

Together, the components form an integrated system to test and report internet connection speeds. Each component's role is critical, and their interplay ensures that the system provides reliable, useful data to the user to understand and potentially troubleshoot their internet connection.

In an aspect, the system (102) may comprise one or more processor(s). The one or more processor(s) may be implemented as one or more microprocessors, microcomputers, microcontrollers, edge or fog microcontrollers, digital signal processors, central processing units, logic circuitries, and/or any devices that process data based on operational instructions. Among other capabilities, the one or more processor(s) may be configured to fetch and execute computer-readable instructions stored in a memory of the system (102). The memory may be configured to store one or more computer-readable instructions or routines in a non-transitory computer readable storage medium, which may be fetched and executed to create or share data packets over a network service. The memory may comprise any non-transitory storage device including, for example, volatile memory such as Random Access Memory (RAM), or non-volatile memory such as Erasable Programmable Read-Only Memory (EPROM), flash memory, and the like.

The database (130) is configured to store the outcomes (data) that are generated as a result of functionalities implemented by any of the components of the system. In an embodiment, the database (130) may be separate from the system (102).

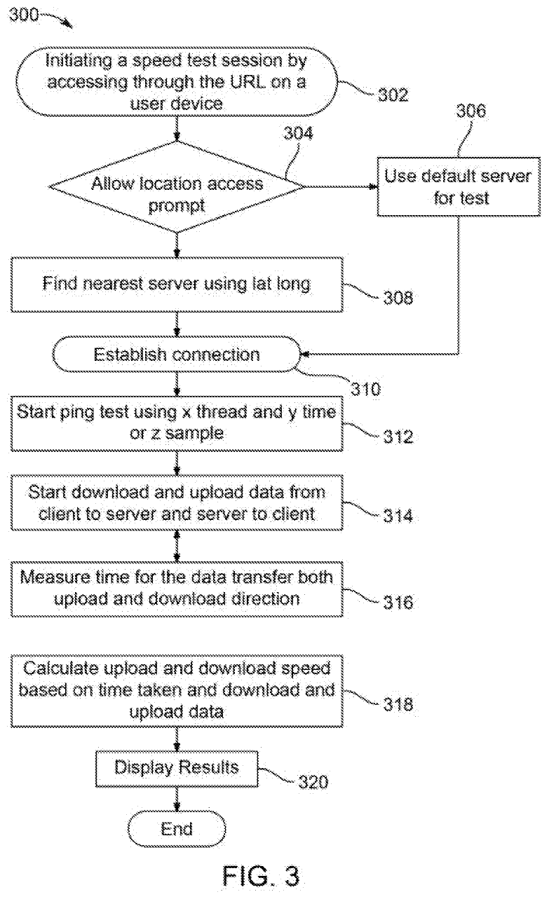

FIG. 3 illustrates an exemplary workflow diagram (300) for enabling URL-based speed tests and data sharing, in accordance with embodiments of the present disclosure. The exemplary flow chart (300) depicts the steps performed by the system (102) for conducting the web-based internet speed test via the URL, in accordance with an embodiment of the present disclosure.

At step (302), a user opens the URL on his/her device's browser, which serves as the entry point for the speed test session. This action initiates the process within the system designed for assessing internet connection speed.

At step (304), the system is configured to prompt the user to allow location access to his user device. If the user consents, the system uses this location data to select the most suitable (nearest) server for the speed test; otherwise, step 306 is followed, where a default server is selected for testing.

At step 308, the nearest server to the user is determined. This determination utilizes latitude and longitude coordinates (data) obtained from the user's device and applies a distance measuring formula calculation to calculate the shortest distance between the user and potential testing servers. For example, a simple process below may be used to calculate the shortest distance and potential test servers using the distance measuring.

$$Latitude in radians = latitude in degrees * π / 180 ;$$

$$Longtitude in radians = longtitude in degrees * π / 180 ;$$

In an aspect, the system is configured to apply a distance measuring formula for calculating the distance between user device's location and each server location. The formula is as follows:
Calculate the differences in latitude (Δlat) and longitude (Δlon) between user device's location and each server location:

$$Δ lat = server latitude in radians - user device ’ s latitude in radians$$

$$Δ lon = server longtitude in radians - user device ’ s longtitude in radians$$

$$a = {sin}^{2} ( Δ lat / 2 ) + cos ( device latitude in radians ) * cos ( server latitude in radians ) * {sin}^{2} ( Δ lon / 2 )$$

$$c = 2 * a tan 2 ( √ a , √ ( 1 - a ) )$$

Calculate the distance (d) using the Earth's radius (r):

$$d = r * c$$

The Earth's radius (r) is typically taken as approximately 6,371 kilometers (3,959 miles).

Once the nearest server is determined, step 310 involves establishing a connection using HTTP/TCP protocols. This connection is necessary for a robust communication pathway for the speed test data packets to be sent to and received from the server.

The testing phase begins at step 312, where the latency test, also known as a ping test, is conducted using a specified number of threads and time or a set number of samples to gauge the network delay accurately. For the latency (ping) test, a client-side application (system) sends a small data packet to the server, and the server responds by sending it back. The system measures the time taken for the round trip, which represents the latency or ping time.

At step 314, the system initiates the download and upload tests by transferring data to and from the server to the user device, which simulates actual internet usage conditions. Further, the downloading speed test, the system instructs the server to send a set amount of data to the user device. The server starts sending the data packets, and the user device receives the data. The server measures the time taken to download them. This measurement calculates the download speed. For calculation download speed, 6 threads were created for 16 seconds and ran 6 parallel HTTP connections to download data from the server to the system using the TCP protocol. For the uploading speed test, the system prepares a set of data packets to be uploaded from the user device to the server. The user device sends these packets back to the server, and the system measures the time taken for the upload. This measurement calculates the upload speed. For calculation upload speed, 6 threads were created for 16 seconds to make 6 parallel HTTP connections and upload a 30 Mb file from the user device to the server using the TCP protocol. Finally, displaying and storing data once the download speed, upload speed, and latency measurements are obtained, the speed test website displays the results to the user and stores data using REST API. In an embodiment, the method (300) further includes a step of conducting the latency test by sending and receiving data packets between the user device and the nearest testing server.

In an embodiment, the method (300) further includes a step of conducting the download speed test by transferring data from the nearest testing server to the user device and calculating the download speed based on a data transfer time.

In an embodiment, the method (300) further includes a step of conducting the upload speed test by transferring data from the user device to the nearest testing server and calculating the upload speed based on the data transfer time.

The method then measures the time taken for data transfer in both directions (upload and download) at step 316, which is critical for calculating the internet speed.

Based on the data gathered in the previous steps, step 318 involves calculating the upload and download speeds by analyzing the time taken and the amount of data transferred. The method further includes calculating a confidence value representing stability of the network using the measured number of data packets. To calculate the confidence level, the system assigns a value to each measured value of the latency, download, and upload speed test results. For instance, a score of 100 is assigned if the latency is less than 100 ms. If the latency falls between 100 ms and 200 ms, a score is assigned based on a linear scale between 0 and 100. The system calculates the difference between download and upload speeds to assign a value corresponding to the speed test result. A score is then assigned based on this difference, where a lower difference results in a higher score. For example, if the difference between download and upload speeds is less than 10 Mbps, a score of 100 is assigned. If the difference is between 10 Mbps and 20 Mbps, a score is assigned based on a linear scale between 0 and 100. The scores from latency and speed are combined, and a weighted average is performed. To calculate the confidence value, the combined score is normalized to a scale of 0 to 100, representing the confidence value. For example, a predefined threshold value corresponding to the confidence value lies in a range of 10-40. In an aspect, the confidence value is a configurable value and may be changed according to the requirements of the network operator.

Finally, step 320 displays the results of the latency, download, and upload tests to the user, concluding the speed test session. Optionally, the system may store these test results for later reference or analysis. The system is configured to display the results of the plurality of conducted speed tests on a display screen of the user device if the calculated confidence value is greater than a predefined threshold value.

In an embodiment, the method (300) further includes a step of reconducting the plurality of speed tests if the calculated confidence value is less than the predefined threshold value.

In an embodiment, the method (300) further includes a step of storing the results of the conducted plurality of tests in a database (130).

This flow chart (300) methodically outlines the user interaction and backend processes that together facilitate the measurement of internet connection speeds through a web-based interface accessible via a simple URL.

In an overall embodiment, the workflow (method) (300) includes establishing an HTTP/TCP Connection where the client-side application (speed test mobile application) on the speed test website establishes a connection to the selected server. The connection allows the client-side code to send and receive data packets to measure the speed and performance of the internet connection.

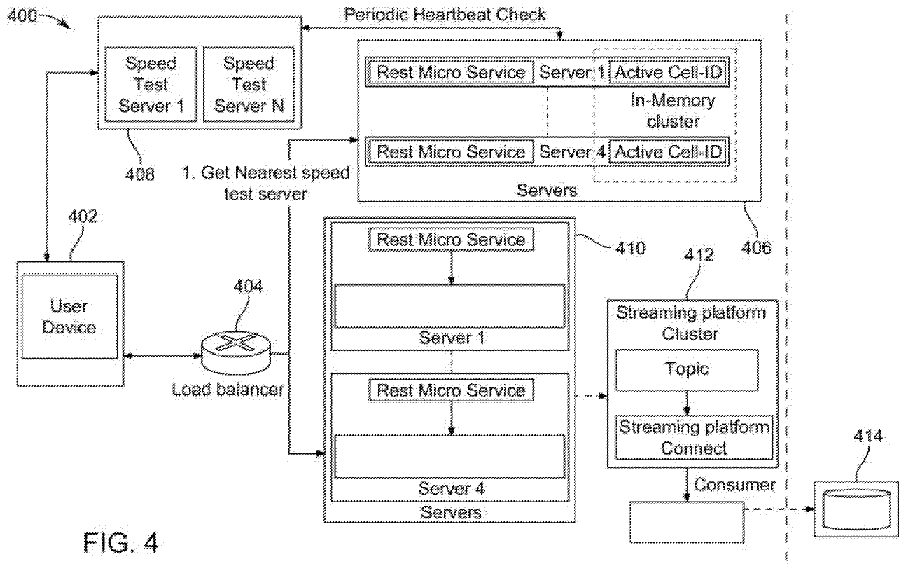

FIG. 4 illustrates an exemplary architecture (400) of the system for conducting the internet speed test, in accordance with embodiments of the present disclosure. As shown in FIG. 4, the system (102) includes at least one user equipment (402), a load balancer (404), a plurality of application servers (406), a plurality of speed test servers (408), a plurality of REST micro service servers (410), a streaming platform cluster (412), a database (414), and a plurality of consumers.

The at least one user equipment (402) may be configured to initiate a speed measurement request. In an example, a user may be configured to initiate the speed measurement request via a speed test mobile application installed in the user equipment (402). In some examples, the speed test mobile application may be a software or a mobile application from an application distribution platform. Examples of application distribution platforms include the App Store for iOS provided by Apple, Inc., Play Store for Android OS provided by Google Inc., and such application distribution platforms. In an example, the speed test mobile application may have access to a number of parameters associated with the user equipment (402) such as current location of the user equipment (402), and files stored within the user equipment (402). In an example, the speed measurement request may include an address information of the user equipment. The address information of the user equipment (402) is a geographical location (longitude and latitude) of the user equipment (402).

A memory of the user equipment (402) is configured to store program instructions. The memory is configured to store the data received from the speed test mobile application. The program instructions include a program that implements a method to initiate the speed test in accordance with embodiments of the present disclosure and may implement other embodiments described in this specification. The memory may be configured to store pre-processed data. The memory may include any computer-readable medium known in the art including, for example, volatile memory, such as Static Random Access Memory (SRAM) and Dynamic Random Access Memory (DRAM) and/or non-volatile memory, such as Read Only Memory (ROM), erasable programmable ROM, flash memories, hard disks, optical disks, and magnetic tapes.

In an aspect, the speed test mobile application may be configured to, via a processing unit, fetch and execute computer-readable instructions stored in the memory of the UE. The processing unit may be configured to execute a sequence of instructions of the method to initiate the speed test, which may be embodied in a program or software. The instructions can be directed to the processing unit, which may subsequently program or otherwise be configured to implement the methods of the present disclosure. In some examples, the processing unit is configured to control and/or communicate with large databases, perform high-volume transaction processing, and generate reports from large databases. The processing unit may be implemented as one or more microprocessors, microcomputers, microcontrollers, digital signal processors, central processing units, state machines, logic circuitries, and/or any devices that manipulate signals based on operational instructions.

The load balancer (dedicated load balancer) (404) is configured to receive the speed measurement request initiated by the at least one user equipment (402). The load balancer (404) may be configured to distribute incoming speed measurement request(s) across the plurality of application servers (406), ensuring no single server is overburdened. The load balancer (404) may be configured to distribute incoming network traffic across the application servers (406). The load balancer (404) may be configured to adjust the distribution of requests dynamically to ensure optimal resource utilization. The load balancer (404) is configured to monitor the health and performance of each application server (406) and directs incoming speed measurement request(s) based on a set of algorithms (round-robin, least connections, etc.). The load balancer (404) is configured to determine an application server (406) based on a number of parameters and forward the received speed measurement request to the determined application server (406). In an example, the number of parameters may include number of active requests serving by each application server (406), and a threshold of requests to be served.

The application server (406) may be configured to receive the speed measurement request from the load balancer (404). In an example, the application server (406) may be configured to extract the location information of the user equipment (402), and based on the extracted location information, the application server may be configured to select a speed test server (408). The speed test server (408) may be selected according to a distance between the user equipment (402) and each speed test server. In an example, the address corresponding to the selected speed test server (408) may be added to a repository (in-memory cluster) associated with the at least one determined application server (406). In an example, the repository may be configured to store structured data for the plurality of application servers (406). The repository may be configured to handle data retrieval, storage, and modification operations based on requests from the application servers. In an example, the location information of the user equipment (402), a geographic location of the user equipment (402) is determined according to the location information of the user equipment (402), the geographic locations of the plurality of speed test servers (408) may be stored in the repository.

In an operative aspect, the application server (406) is configured to receive the speed measurement request (a scheduled speed test request) along with latitude and longitude data from the user. The application server (406) is configured to select the nearest speed test server (408) based on the latitude and longitude data. In an example, the application server (406) is configured to first check, via an application programming interface (API), the latitude and longitude data in the ‘in-memory cluster’ (cache memory of the application server(s) such that a recently connected testing server may be assigned. Further, the application server (406) may respond back to the load balancer (404) and the user equipment (402) with details of the selected speed test server (408).

In an operative aspect, the application server (406) is configured to employ periodic heartbeat checks to ensure the reliability of the system. This mechanism continuously monitors the health of the speed test servers (408), verifying that each test server is functional and ready to handle new requests.

For example, the selected speed test server (408) may be the nearest test server for the user equipment (402). In an example, the application server (406) may be configured to determine the nearest server based on a latitude and longitude of the user equipment (102). In another aspect, the nearest test server for the user equipment (102) may be selected on the distance measured between the user device and the servers. In an example, the application server (406) may be configured to process the user requests, execute business logic, and generate responses.

The plurality of speed test servers (408) is configured to receive the request from the application server (406) and is further configured to execute the speed measurement request. The speed test server (408) may be used to measure the speed of the network in which the user's equipment (402) resides. The speed test server (408) may be configured to simulate various network conditions to evaluate the speed and responsiveness of the system (102). The speed test server (408) may be further configured to collect and analyze performance metrics, such as latency, throughput, and response times. The speed test server (408) may be configured to offer a standardized environment for users to assess their network or application performance. After executing the speed measurement request, the selected speed test server (408) may be configured to generate at least one speed test information (result test or active data). In an aspect, the at least one speed test information may include a measured downlink (DL) speed and/or a measured uplink (UL) speed. In an example, the speed test server (408) may be configured to transmit the at least one speed test information (result test) to the user equipment (402) via the speed test mobile application. The speed test server (408) may be configured to analyze the at least one speed generated test information. The speed test server (408) may be configured to store the analyzed test information in the database (414) via the streaming platform cluster (412).

After completion of the speed test, the speed test server (408) may be configured to synchronize the result data using a Data Sync API to the database (414) using a configuration having the plurality of REST micro service servers (410) (also referred to as a plurality of RESTful micro service servers), the streaming platform cluster (412) and the plurality of consumers. In an example, a JSON based data structure may be used for the speed test result. After receiving the result test from the speed test server (408), the user equipment (402) is configured to share the speed test result with the load balancer (404). The user equipment (402) may be configured to synchronize the active data (speed test result) with the dedicated load balancer (404). The dedicated load balancer (404) is further configured to synchronize the active data (speed test result) with the plurality of REST micro service servers (410). The dedicated load balancer (404) is configured to share the data received from the user equipment (402) to at least one producer from the plurality of REST micro service servers (410).

The plurality of RESTful micro service servers (410) is configured to receive the active data and generate published or streamed data. The plurality of RESTful micro service servers (410) is typically located externally to the streaming platform cluster (412) and may additionally be external to the physical computing clusters or data centres upon which the streaming platform cluster (412) resides. For example, a producer might be a computing device connected to a plurality of user equipment and the load balancer (104) for generating streamed data, such that the computing device uses a wired or wireless communication network or series of networks to stream the active data from each user equipment (102) to the streaming platform cluster (412).

The streaming platform cluster (412) may be configured to manage an efficient and reliable transfer of data between different components of the system (102). In an example, the streaming platform cluster (412) may be configured to enable real-time communication and data transfer. The streaming platform cluster (412) may be configured to facilitate real-time communication between different components, such as the user equipment, the application servers, and the load balancer (404).

The plurality of RESTful micro service servers (410) enables independence and ensures smooth scalability and maintainability of the system. The streaming platform cluster (412) is providing a fault-tolerant platform for handling real-time data streams. It acts as a message broker between the REST Micro Services and the rest of the system, facilitating the efficient flow of data and ensuring that all components are updated with the latest information relevant to the speed tests.

Data generated from the speed tests is systematically stored and managed in the database (414). The database (414) is configured as a repository, keeping a record of test results and metrics which can be analyzed to provide insights into internet speed and system performance.

In the system, each component is interdependent. The system is configured to perform a web-based internet speed test efficiently and reliably by utilizing distributed services and a scalable architecture that can accommodate a large number of concurrent users.

The streaming platform cluster (412) is a framework that includes producers, consumers, different brokers, topics, and their respective partitions. Data is written to the topic within the cluster. A producer sends or writes data to the topic within the cluster. In order to store a huge amount of data, different producers (for example, the plurality of servers) within an application send data to the streaming platform cluster (412). The plurality of consumers is configured to read or consume messages from the streaming platform cluster (412). There can be several consumers consuming different types of data form the cluster. A broker (server) is a bridge between the producers and the consumers. A topic is a common heading given to represent a similar type of data. There can be multiple topics in a cluster. Each topic specifies different types of messages. Further, the streaming platform cluster (412) is configured to consume the data and directly store the consumed data in the database (414) or in a database management system. In an example, the database management system is Hbase. The Hbase is configured to store the data with Date wise partition. In an example, the HBase is a column-oriented non-relational database management system. In an aspect, the HBase may be configured to operate with a Hadoop Distributed File System (HDFS). HDFS is a distributed file system that handles large data sets running on commodity hardware. In an aspect, a plurality of hive tables may be created on HDFS partitioned data for further use cases and reporting.

The present system (102) may be configured to employ a distributed architecture, thereby enhancing scalability, fault tolerance, and overall system performance, suitable for handling varying loads and ensuring a smooth user experience. The present system (102) may be configured to provide a backend architecture of vary important feature used for the speed test in various mobile applications. In an aspect, the present system (102) may be applicable to 2G, 3G, 4G, 5G, 6G and beyond all generation of mobile technology with multiple bands and carriers of telecom operators.

By employing the various dedicated speed test servers (408) at different location for speed test, the present system (102) may be configured to reduce latency of the mobile applications considerably.

As a dedicated speed test server (408) is available for handling the request, the present system (102) may be configured to respond fast hence the mobile application response time is reduced considerably.

Since calls are diverted to various application servers (106406) using a round-robin form, therefore no server gets overloaded with the requests. In an aspect, multiple application servers and speed test servers may be added with the system (102) as per requirement without changing in the system architecture.

The present system (102) may be configured to provide an accurate internet speed of the network to a customer (user) and a network operator, thereby helping in real-time troubleshooting of network issues. In an aspect, the system (102) may be configured to monitor network performance in a global area.

By using the architecture, the system (102) may be configured to improve latency as well as the accuracy of speed test data using the nearest test server. The speed test data can be used by the network operator or organization to troubleshoot any customer-centric issue (by running a speed test in their area).

In an operative aspect, the system is configured to perform the following steps:
Start the Speed Test: Visit a speed test website or launch a speed test application on the user device.
Allow Location Access, if prompted, grant the speed test website or application permission to access user device's location information. This allows the system to determine an approximate location of the user device.
Find Nearest server using latitude and longitude and employing periodic Heartbeat Check, the system is able to manage list of all servers with latitude and longitude. In an example, in every 60 second the system checks whether a server running or not.
Obtain the Latitude and Longitude: Gather the latitude and longitude coordinates for both user device's location and the available server locations. These coordinates can usually be obtained from various sources, such as GPS devices, online maps, or geolocation services. Convert degrees to radians by converting the latitude and longitude values from degrees to radians. This conversion is necessary for accurate distance calculations in the system.

$$Latitude in radians = latitude in degrees * π / 180$$

$$Longtitude in radians = longtitude in degrees * π / 180$$

Furthermore, apply the distance measuring formula to calculate the distance between the user device's location and each server location. The formula is as follows:
   Calculate the differences in latitude (Δlat) and longitude (Δlon) between the user device's location and each server location:

$$Δ lat = server latitude in radians - user device ’ s latitude in radians$$

$$Δ lon = server longtitude in radians - user device ’ s longtitude in radians$$

$$a = {sin}^{2} ( Δ lat / 2 ) + cos ( latitude of user device in radians ) * cos ( server latitude in radians ) * {sin}^{2} ( Δ lon / 2 )$$

$$c = 2 * a tan 2 ( √ a , √ ( 1 - a )$$

Calculate the distance (d) using the Earth's radius (r):

$$d = r * c$$

Further, determine the nearest server: compare the calculated distances for each server, and identify the server with the shortest distance. The server is considered the nearest one to the user device's location.

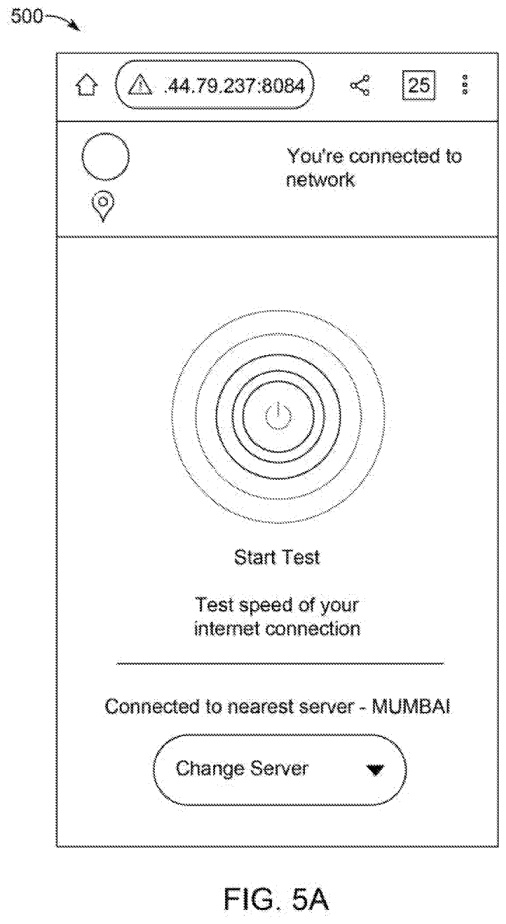

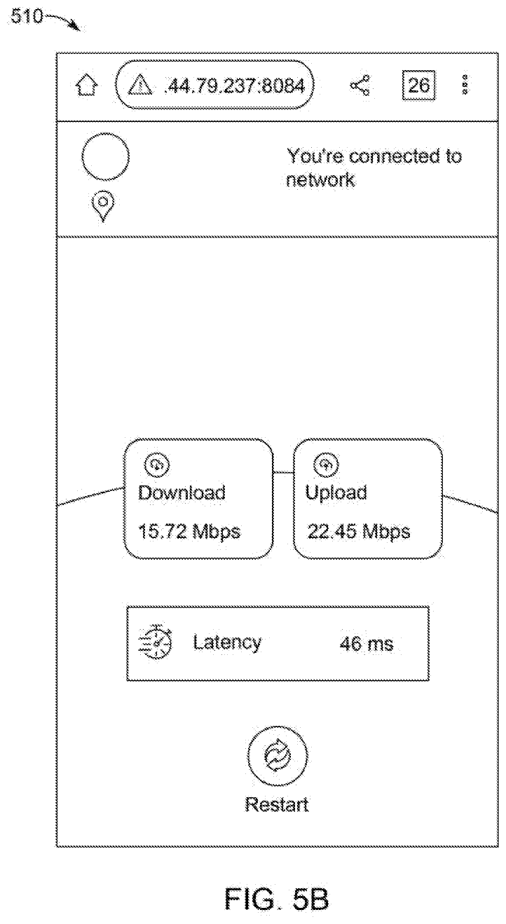

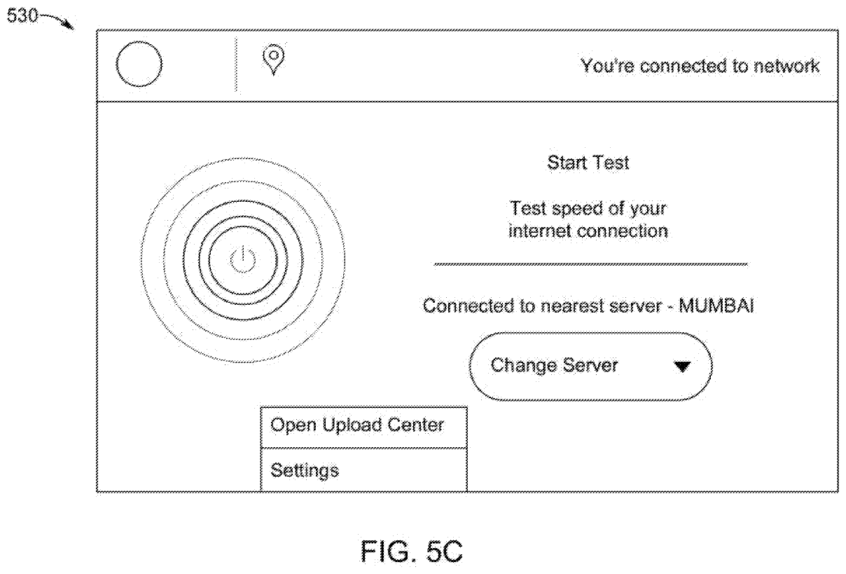

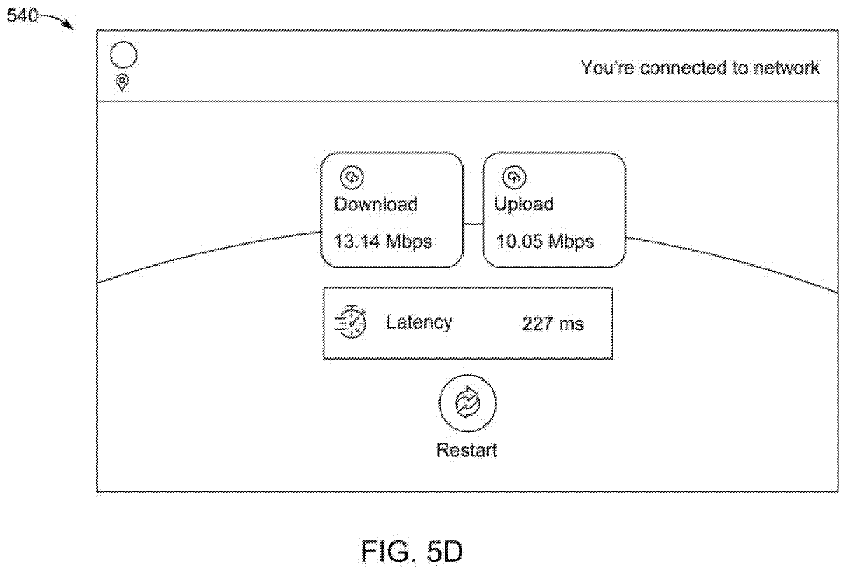

FIGS. 5A-5D illustrate various exemplary user interfaces representing various pages of the speed test mobile application, in accordance with embodiments of the present disclosure.

FIG. 5A represents a home page (500) of the speed test mobile application from where the speed test can be started. The home page (500) of the speed test mobile application is typically the first screen or landing page that users encounter when they open the application. It serves as the main entry point and provides an overview of the app's features, functionalities, and content.

FIG. 5B represents a result page (510) representing results after conducting the speed test. The latency test measures the delay or latency between the user device and the server or destination on the internet. The download speed test measures the speed at which data can be downloaded from the internet to the user device. The download speed test helps in determining the rate at which the internet connection can transfer data and is typically measured in megabits per second (Mbps) or kilobits per second (Kbps). As illustrated in FIG. 5B, showing a download speed measurement (e.g., 15.72 Mbps). The upload speed test measures the speed at which data can be uploaded from the user device to the internet. As illustrated in FIG. 5B, showing an upload speed measurement (e.g., 22.45 Mbps). As illustrated in FIG. 5B, showing a latency (e.g., 46 ms).

FIG. 5C represents a setting page (530) via which the user is able to change an upload center/server. FIG. 5D represents a speed test result page represents a result page (540) representing results after reconducting the speed test using the updated server. As illustrated in FIG. 5D, showing a download speed measurement (e.g., 13.14 Mbps). The upload speed test measures the speed at which data can be uploaded from the user device to the internet. As illustrated in FIG. 5D, showing an upload speed measurement (e.g., 10.05 Mbps). As illustrated in FIG. 5D, showing a latency (e.g., 227 ms).

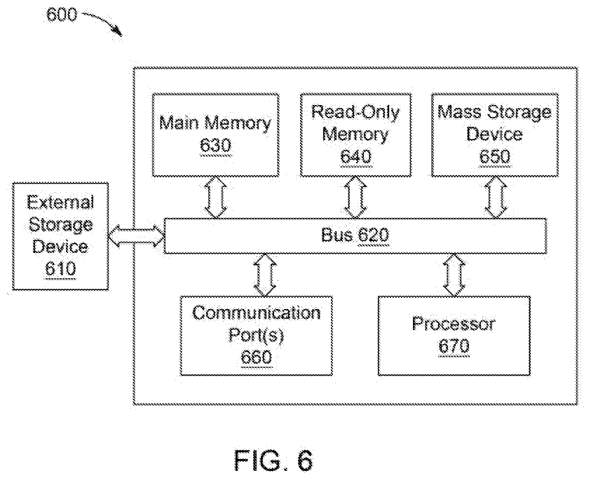

FIG. 6 illustrates an exemplary computer system 600 in which or with which embodiments of the present disclosure may be implemented. In an example, the computer system is a user equipment.

As shown in FIG. 6, the computer system 600 may include an external storage device 610, a bus 620, a main memory 630, a read-only memory 640, a mass storage device 650, communication port(s) 660, and a processor 670. A person skilled in the art will appreciate that the computer system 600 may include more than one processor and communication ports. The processor 670 may include various modules associated with embodiments of the present disclosure. The communication port(s) 660 may be any of an RS-232 port for use with a modem-based dialup connection, a 10/(100) Ethernet port, a Gigabit or 10 Gigabit port using copper or fiber, a serial port, a parallel port, or other existing or future ports. The communication port(s) 660 may be chosen depending on a network, such a Local Area Network (LAN), Wide Area Network (WAN), or any network to which the computer system 600 connects. The main memory 630 may be random access memory (RAM), or any other dynamic storage device commonly known in the art. The read-only memory 640 may be any static storage device(s) including, but not limited to, a Programmable Read Only Memory (PROM) chips for storing static information e.g., start-up or basic input/output system (BIOS) instructions for the processor 670. The mass storage device 650 may be any current or future mass storage solution, which may be used to store information and/or instructions.

The bus 620 communicatively couples the processor 670 with the other memory, storage, and communication blocks. The bus 620 can be, e.g. a Peripheral Component Interconnect (PCI)/PCI Extended (PCI-X) bus, Small Computer System Interface (SCSI), universal serial bus (USB), or the like, for connecting expansion cards, drives, and other subsystems as well as other buses, such a front side bus (FSB), which connects the processor 670 to the computer system 600.

Optionally, operator and administrative interfaces, e.g. a display, keyboard, and a cursor control device, may also be coupled to the bus 620 to support direct operator interaction with the computer system 600. Other operator and administrative interfaces may be provided through network connections connected through the communication port(s) 660. In no way should the aforementioned exemplary computer system 600 limit the scope of the present disclosure.

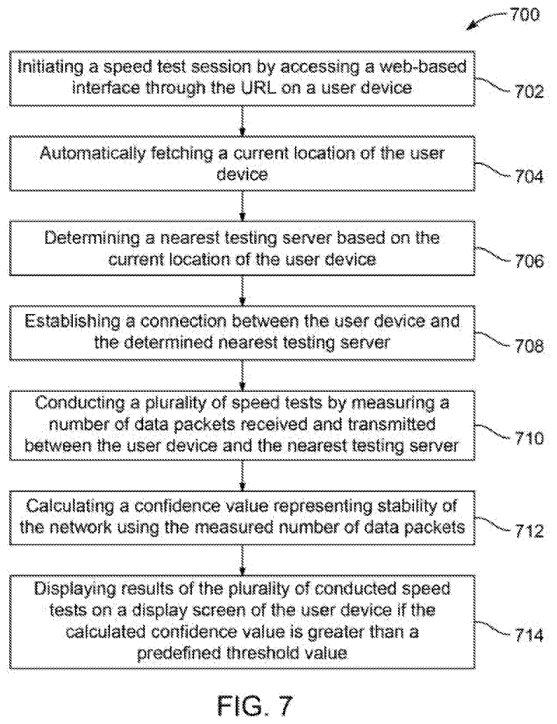

FIG. 7 illustrates exemplary steps of a method (700) for conducting an internet speed test for the network via the URL, in accordance with embodiments of the present disclosure.

At step (702), the system initiates a speed test session by accessing a web-based interface through the URL on the user device.

At step (704), the system automatically) fetches a current location of the user device. In an example, the system is configured to prompt the user to allow location access to his user device. If the user consents, the system uses this location data to select the most suitable (nearest) server for the speed test; otherwise, step 306 is followed, where a default server is selected for testing.

At step (706), the system determines the nearest testing server based on the current location of the user device.

At step (708), the system establishes a connection between the user device and the determined nearest testing server. In an example, the connection is a Hypertext Transfer Protocol (HTTP) connection or a Transmission Control Protocol (TCP) connection.

At step (710), the system conducts a plurality of speed tests by measuring a number of data packets received and transmitted between the user device and the nearest testing server. In an example, the plurality of speed tests includes a latency test, a download speed test, and an upload speed test.

At step (712), the system calculates a confidence value representing the stability of the network using the measured number of data packets.

At step (714), the system displays the results of the plurality of conducted speed tests on a display screen of the user device if the calculated confidence value is greater than a predefined threshold value.

In an embodiment, the method further includes a step of reconducting the plurality of speed tests if the calculated confidence value is less than the predefined threshold value.

In an embodiment, the method further includes a step of conducting the latency test by sending and receiving data packets between the user device and the nearest testing server.

In an embodiment, the method further includes a step of conducting the download speed test by transferring data from the nearest testing server to the user device and calculating the download speed based on a data transfer time.

In an embodiment, the method further includes a step of conducting the upload speed test by transferring data from the user device to the nearest testing server and calculating the upload speed based on the data transfer time.

In an exemplary aspect, the present disclosure envisages a user equipment that is configured to conduct an internet speed test for a network via a universal resource locator (URL). The user equipment includes a processor, and a computer readable storage medium storing programming instructions for execution by the processor. Under the programming instructions, the processor is configured to receive a test session initiation request by a user through the URL on the user equipment. Under the programming instructions, the processor is configured to fetch a current location of the user equipment via a location access component. Under the programming instructions, the processor is configured to receive the current location of the user equipment using a server selection unit and select a nearest testing server based on the received location of the user device. Under the programming instructions, the processor is configured to establish a connection with the determined nearest testing server. Under the programming instructions, the processor is configured to conduct a plurality of speed tests by measuring a number of data packets received and transmitted between the user equipment and the nearest testing server. Under the programming instructions, the processor is configured to calculate a confidence value using the measured data packets for the network under test. Under the programming instructions, the processor is configured to display results of the plurality of conducted speed tests on a display screen of the user equipment if the calculated confidence value is greater than a threshold value.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter to be implemented merely as illustrative of the disclosure and not as limitation.

### Advantages of the Present Disclosure

The present disclosure provides a system and method enabling URL based speed test and data sharing.

The present disclosure analyses network performance, improving the service, and generating aggregate statistics.

The present disclosure reviews the privacy policy and terms of service of the speed test provider before conducting a test.

The present disclosure implements encryption protocols and following industry-standard practices to protect data from unauthorized access or breaches.

1. A method (700) of conducting an internet speed test for a network via a universal resource locator (URL), the method comprising:
initiating (702) a speed test session by accessing a web-based interface through the URL on a user device;
automatically (704) fetching a current location of the user device;
determining (708) a nearest testing server based on the current location of the user device;
establishing (710) a connection between the user device and the determined nearest testing server;
conducting (712) a plurality of speed tests by measuring a number of data packets received and transmitted between the user device and the nearest testing server;
calculating (714) a confidence value representing stability of the network using the measured number of data packets; and
displaying (716) results of the plurality of conducted speed tests on a display screen of the user device if the calculated confidence value is greater than a predefined threshold value.

2. The method (700) as claimed in claim 1, wherein the plurality of speed tests includes a latency test, a download speed test, and an upload speed test.

3. The method (700) as claimed in claim 1, further comprising reconducting the plurality of speed tests if the calculated confidence value is less than the predefined threshold value.

4. The method (700) as claimed in claim 1, further comprising conducting the latency test by sending and receiving data packets between the user device and the nearest testing server.

5. The method (700) as claimed in claim 1, further comprising conducting the download speed test by transferring data from the nearest testing server to the user device and calculating the download speed based on a data transfer time.

6. The method (700) as claimed in claim 1, further comprising conducting the upload speed test by transferring data from the user device to the nearest testing server and calculating the upload speed based on the data transfer time.

7. The method (700) as claimed in claim 1, further comprising storing the results of the plurality of conducted tests in a database (130).

8. The method (700) as claimed in claim 1, wherein the connection is a Hypertext Transfer Protocol (HTTP) connection or a Transmission Control Protocol (TCP) connection.

9. A system (102) for conducting an internet speed test for a network via a universal resource locator (URL), the system comprising:
a web-based interface (112) configured to receive a test session initiation request from a user through the URL on a user device;
a location access component (114), on receiving the test session initiation request, is configured to fetch a current location of the user device;
a server selection unit (116) configured to cooperate with the location access component (114) to receive the current location of the user device, and further configured to determine a nearest testing server based on the received location of the user device;
a network connection component (118) configured to establish a connection between the user device and the determined nearest testing server; and
a testing component (120) configured to conduct a plurality of tests by measuring a number of data packets received and transmitted between the user device and the nearest testing server, is further configured to:
calculate a confidence value using the measured data packets for the network under test; and
display results of the plurality of conducted speed tests on a display screen (128) of the user device if the calculated confidence value is greater than a threshold value.

10. The system (102) as claimed in claim 9, wherein the plurality of tests includes a latency test, a download speed test, and an upload speed test.

11. The system (102) as claimed in claim 9, wherein the testing component (120) is configured to reconduct the plurality of speed tests if the calculated confidence value is less than the threshold value.

12. The system (102) as claimed in claim 10, wherein the testing component (120) is configured to conduct the latency test, via a latency testing component (122), by sending and receiving data packets between the user device and the nearest testing server.

13. The system (102) as claimed in claim 10, wherein the testing component (120) is configured to conduct the download speed test, via a download speed testing component (124), by transferring data from the nearest testing server to the user device and calculating the download speed based on a data transfer time.

14. The system (102) as claimed in claim 10, wherein the testing component (120) is configured to conduct the upload speed test, via an upload speed testing component (126), by transferring data from the user device to the nearest testing server and calculating the upload speed based on the data transfer time.

15. The system (102) as claimed in claim 9, wherein the connection is a Hypertext Transfer Protocol (HTTP) connection or a Transmission Control Protocol (TCP) connection.

16. The system (102) as claimed in claim 9, wherein the location access component (114) is configured to utilize a Geolocation Application programming interface (API) provided by a web browser to obtain the geographic position of the user device.

17. A user equipment configured to conduct an internet speed test for a network via a universal resource locator (URL), the user equipment comprising:
a processor; and
a computer readable storage medium storing programming instructions for execution by the processor, the programming including instructions to:
receive a test session initiation request by a user through the URL on the user equipment;
fetch a current location of the user equipment via a location access component (114);
receive the current location of the user equipment using a server selection unit (116), and select a nearest testing server based on the received location of the user device;
establish a connection with the selected nearest testing server;
conduct a plurality of speed tests by measuring a number of data packets received and transmitted between the user equipment and the nearest testing server;
calculate a confidence value using the measured data packets for the network under test; and
display results of the plurality of conducted speed tests on a display screen of the user equipment if the calculated confidence value is greater than a threshold value.

18. The user equipment as claimed in claim 17, wherein the plurality of tests includes a latency test, a download speed test, and an upload speed test.

19. The user equipment as claimed in claim 17, wherein the processor is configured to reconduct the plurality of speed tests if the calculated confidence value is less than the threshold value.

20. A computer program product comprising a non-transitory computer-readable medium comprising instructions that, when executed by one or more processors, cause the one or more processors to:
receive a test session initiation request by a user through a universal resource locator (URL) on a user device;
fetch a current location of the user device via a location access component (114);
receive the current location of the user device using a server selection unit (116), and determine a nearest testing server based on the received location of the user device;
establish a connection between the user device and the determined nearest testing server;
conduct a plurality of speed tests by measuring a number of data packets received and transmitted between the user device and the nearest testing server;
calculate a confidence value using the measured data packets for the network under test; and
display results of the plurality of conducted speed tests on a display screen of the user device if the calculated confidence value is greater than a threshold value.
